(19) United States
(12) Patent Application Publication
(10) Pub. No.: US 2026/0232037 A1
(43) Pub. Date: Aug. 13, 2026

(54) Aerosol Generating Device

(71) Applicant: JT International SA, Geneva (CH)

(72) Inventor: Alec Wright, Guildford (GB)

(73) Assignee: JT International SA, Geneva (CH)

(21) Appl. No.: 19/152,636

(22) PCT Filed: Feb. 16, 2024
(86) PCT No.: PCT/EP2024/053958

§ 371 Date: Jul. 31, 2025

(30) Foreign Application Priority Data
Feb. 24, 2023 (EP) 23158432.7

(51) Int. Cl. A24F 40/51; A24F 40/20; A24F 40/70

(52) U.S. Cl. CPC A24F 40/51; A24F 40/20; A24F 40/70

(57) ABSTRACT

An aerosol generating device (100) is configured to generate an aerosol for inhalation by a user is disclosed and comprises: a cavity (106) configured to receive a consumable (10) comprising an aerosol generating substance; a heater (104) positioned adjacent the cavity, configured to heat the consumable to generate an aerosol; a sensor (114) configured to measure a quantity that enables the temperature of the heater to be determined; and a frame (116) configured to hold the temperature sensor between the frame and a surface of the aerosol generating device; wherein the frame is thermally moulded to the surface, such that the frame is sealed to the surface, to hold the sensor in position.

### FIELD OF INVENTION

The invention relates to aerosol generating devices. In particular, the invention relates to aerosol generating devices with a sensor.

### BACKGROUND TO THE INVENTION

Some aerosol generating devices use a sensor, such as a thermistor or a thermocouple, to monitor the temperature of a heater of the device. This information can be used to control the level of power provided to the heater to generate a desired amount of heat. The device may be calibrated to provide the optimal delivery of power for a given monitored temperature. If the sensor moves or becomes dislodged during use, this can cause the power delivered to the heater to be adversely affected, thereby reducing the working lifetime of the aerosol generating device.

In some known devices, polyimide tape is used to fix the sensor in place. However, this approach has been found to be unreliable or ineffective, especially in certain types of aerosol generating devices.

It is an object of the present invention to address these issues.

### SUMMARY OF INVENTION

According to an aspect of the present invention there is provided an aerosol generating device configured to generate an aerosol for inhalation by a user, comprising: a cavity configured to receive a consumable comprising an aerosol generating substance; a heater positioned adjacent the cavity, configured to heat the consumable to generate an aerosol; a sensor configured to measure a quantity that enables the temperature of the heater to be determined; and a frame configured to hold the temperature sensor between the frame and a surface of the aerosol generating device; wherein the frame is thermally moulded to the surface, such that the frame is sealed to the surface, to hold the sensor in position.

In this way, the frame provides a more robust attachment mechanism for the sensor. The frame is sealed to the surface and holds the sensor securely in position, thereby preventing movement of the frame or sensor during usage of the aerosol generating device. In turn, this enables the level of power delivered to the heater to remain consistent over the lifetime of the aerosol generating device, which can extend the lifetime of the device. In some examples, the frame may be thermally moulded to the surface by a process of “overmoulding” or “heat staking”. In general, using thermal moulding as a process of attachment can provide a more robust attachment to the surface compared to other methods because it can enable the frame to conform to the contours and features of the surface while the frame material is in a melted or malleable state. Attaching the frame to the surface by thermal moulding can therefore provide a strong connection between the frame and the surface.

The sensor may be positioned against the same surface to which the frame is thermally moulded. In one example, this may be the case when the frame is thermally moulded to the surface by overmoulding. Alternatively, the sensor may be positioned against an opposing surface to which the frame is thermally moulded. In one such example, the frame may hold the sensor against a first surface and comprise legs that extend through holes in the first surface to brace against an opposing second surface. The legs may be thermally moulded to the opposing second surface, which can be implemented using heat staking. In this case, the sensor is nevertheless positioned between the frame and the second surface.

The frame may fully enclose the sensor. For example, the frame may be moulded about the sensor such that the sensor is completely enclosed between the frame and an adjacent surface. In another example, the frame may have a cup shape, wherein the sensor is retained tightly within the cup and surrounded by the frame and an adjacent surface. Alternatively, the frame may partially enclose the sensor. For example, the frame may have a band or arm wrapped around the sensor to hold the sensor against an adjacent surface.

The frame may be sealed tightly to clamp the sensor in place. Thus, the frame may also be described as a clamp.

The sensor can be any suitable temperature sensor configured to measure a temperature directly. For example, the sensor may comprise a thermocouple or a thermistor. In this case, the sensor may measure the temperature of the heater directly, or, in other words, may have direct thermal contact with the heater. Alternatively, the sensor can measure the temperature of the cavity or some other component of the aerosol generating device that has a temperature dependent on that of the heater, thereby allowing the temperature of the heater to be inferred. In other embodiments, the sensor can be a different type of sensor configured to measure a quantity related to temperature that can be used to derive, calculate or infer a temperature. For example, the sensor can be a device or circuit configured to measure the electrical resistance of the heater itself, or a component in thermal contact with the heater.

If the heater comprises a plurality of separated heating plates or elements, each may comprise a respective frame configured to hold a respective sensor against or between a corresponding surface. Each frame may be further configured to hold a corresponding sensor in position and each frame may be thermally moulded to the respective surface, such that each frame is sealed to each respective surface.

Preferably, the surface is a surface of the heater. The sensor may be positioned directly on a surface of the heater. In this way, the sensor is positioned to enable the temperature of the heater, or another quantity of the heater related to temperature, to be measured directly. This positioning of the frame and sensor may be particularly convenient to implement. In other embodiments, the sensor could be positioned on any other suitable surface of the aerosol generating device that allows a quantity to be measured that enables a determination of the temperature of the heater. For example, the sensor could be positioned on an internal surface of a housing and configured to measure an optical property of a surface of the heater.

Preferably, the surface is substantially flat. Some known attachment mechanisms, such as polyimide tape, have been found to be ineffective when used to attach a sensor to a flat surface. This may be due to a lack of inward tension produced by tape when applied to a flat surface, and it may also be due to degradation in the tape over time. The frame of the present invention does not suffer from this drawback and can be used to provide a more secure attachment means for sensors applied to curved or flat surfaces. Thus, when the frame is holds the sensor against a substantially flat surface the frame can be particularly advantageous over known mechanisms.

Preferably, the surface comprises one or more bonding features configured to engage with the frame. In this way, the frame can attach to the surface more securely. In one example, the bonding features can comprise one or more grooves or recesses into which the frame is moulded. In another example, the bonding features may include a hole passing through the entire thickness of the wall to which the surface belongs. The bonding features may comprise a combination of different types of bonding features, for example a hole and a recess.

Preferably, at least one of the one or more bonding features comprises one or more holes that are provided through the surface. In this way, the frame can be inserted through the one or more holes and brace against an opposing surface. This allows the frame to be attached to the surface more securely.

Preferably, the frame comprises a securing portion that extends through the one or more holes, thereby securing the frame to the surface. In one example, the securing portion may comprise a lug or stud having a width larger than that of the one or more holes. This allows the frame to be riveted to the surface to provide a more secure attachment means.

Preferably, the frame comprises PEEK. In this way, the frame is made from a heat-resistant material that can tolerate the high operating temperature of the heater without melting or becoming deformed. In other embodiments, the frame may comprise any other suitable materials that preferably have a melting point higher than the operating temperatures of the heater. In particular, the frame may comprise other thermoplastic materials.

Preferably, the sensor comprises a temperature sensor. In this way, the sensor can measure temperature directly, which may be more convenient than indirect measurement.

Preferably, the heater comprises ceramic. In other embodiments, the heater could comprise other suitable materials, such as metal.

Preferably, the heater is configured to heat a consumable comprising tobacco. In this way, the aerosol generating device can operate as a heat-not-burn device, wherein the heater heats the consumable to temperatures below the combustion temperature of tobacco. Such devices typically operate at relatively high temperatures for prolonged time periods, such as 5 minutes, in each session of use. Prolonged use of the heater in this way can degrade known types of attachment means, such as tape provided with a sealant, more rapidly compared to other types of aerosol generating devices. Providing a more secure attachment mechanism may therefore provide a more pronounced benefit in heat-not-burn devices.

Preferably, the cavity is configured to receive a substantially planar consumable. As described previously, providing a secure attachment of the sensor to a substantially flat surface can be particularly difficult. Including the frame of the present invention can be particularly helpful in a generally planar aerosol generating device configured to receive a substantially planar consumable.

According to a further aspect of the invention there is provided a method of manufacturing an aerosol generating device, comprising: heating a frame material; positioning a sensor between the frame material and a surface; moulding the frame material to the surface; and cooling the frame material to form a seal with the surface such that the frame holds the sensor in position.

The step of moulding the frame material to the surface may be performed using any suitable process, such as heat staking or overmoulding. The sensor can be positioned between the frame material and the surface before, after, or during the process of moulding and sealing the frame material to the surface, depending on the particular method of sealing the frame to the surface.

Preferably, the method further comprises moulding the frame material to at least one of one or more bonding features in the surface. This enables the frame material to form a stronger connection with the surface once cooled.

Preferably, the method further comprises, before the step of heating the frame material, extending a securing portion of the frame material through one or more holes in the surface. In this way, the frame can be riveted against the surface to provide a more secure attachment.

### BRIEF DESCRIPTION OF THE DRAWINGS

Embodiments of the invention are now described, by way of example, with reference to the drawings, in which:

FIG. 1 shows a perspective view of an aerosol generating device according to an embodiment of the invention;

FIG. 2 shows a schematic control diagram of an aerosol generating device according to an embodiment of the invention;

FIG. 3 shows a schematic cross-sectional view of a portion of an aerosol generating device according to an embodiment of the invention;

FIG. 4 shows a schematic cross-sectional view of a portion of an aerosol generating device according to an embodiment of the invention;

FIG. 5 shows a schematic cross-sectional view of a portion of an aerosol generating device prior to manufacturing of the device according to an embodiment of the invention;

FIG. 6A shows a schematic view of a manufacturing process step for manufacturing an aerosol generating device according to an embodiment of the invention;

FIG. 6B shows a schematic view of a manufacturing process step for manufacturing an aerosol generating device according to an embodiment of the invention; and

FIG. 7 shows a method of securing a sensor to a surface to manufacture an aerosol generating device according to an embodiment of the invention.

### DETAILED DESCRIPTION OF THE DRAWINGS

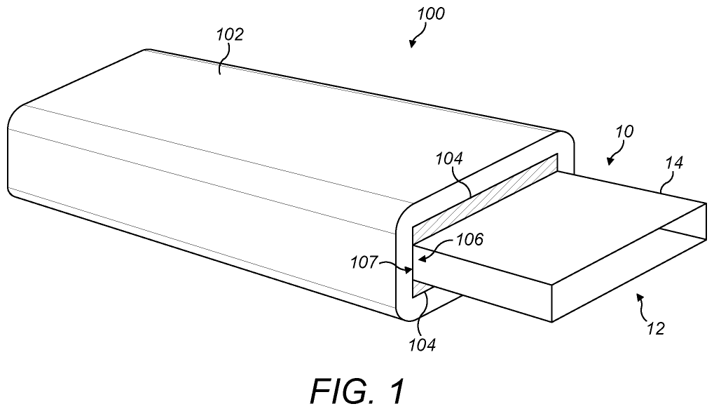

FIG. 1 shows a perspective view of an aerosol generating device according to an embodiment of the invention. An aerosol generating device 100 is provided and comprises a housing 102 configured to house internal components of the aerosol generating device 100. A heater 104 comprising two parallel ceramic heating plates that are spaced apart to provide a cavity 106 therebetween is provided within the housing 102. The cavity 106 is accessible through an opening 107 in the housing 102. In FIG. 1, a consumable 10 is positioned in the cavity 106 through the opening 107. The consumable 10 comprises a mouthpiece portion 12, shown in FIG. 1 as protruding from the cavity 106, which has an air channel that enables a user to draw aerosol from the cavity 106. A main body portion (not shown) of the consumable 10, containing tobacco, is positioned between the parallel heating plates of the heater 104 and is obscured from view. The consumable 10 comprises a wrapping 14, which forms the mouthpiece portion 12 and contains the main body portion. An air inlet (not shown) is provided on the housing 102 in fluidic communication with the cavity 106 to enable a user to inhale generated aerosol from the cavity 106 through the mouthpiece portion 12.

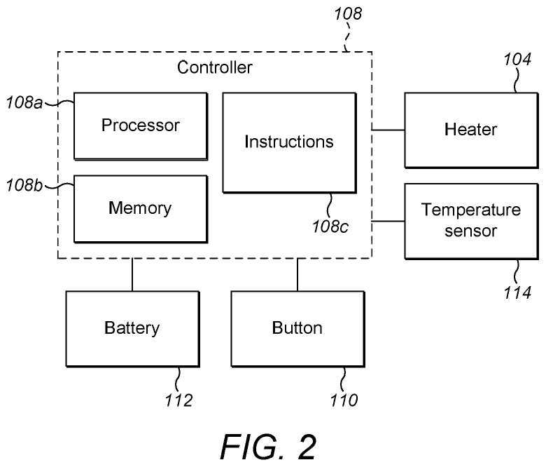

FIG. 2 shows a schematic control diagram for the aerosol generating device 100 of FIG. 1. As shown in FIG. 2, the aerosol generating device 100 further comprises a controller 108 for controlling operations of the aerosol generating device 100. The controller 108 comprises at least one processor 108a and a memory 108b for storing and executing instructions 108c, respectively. The heater 104 is provided in electrical connection with the controller 108 so that the controller 108 can turn the heater 104 on or off in response to instructions from a user. A button 110 is provided on the housing 102 for receiving input from a user to turn the heater 104 on or off. A battery 112 is provided for powering the electronic components of the aerosol generating device 100, including the heater 104 and the controller 108. A temperature sensor 114 is provided on the heater 104 and in electrical connection with the controller 108. The temperature sensor 114 relays a measured temperature of the heater 104 to the controller 108. This allows the controller 108 to adjust the level of power delivered from the battery 112 to the heater 104 based on the measured temperature, for example using an algorithm stored in the memory 108b. The components of the aerosol generating device 100 shown in FIG. 2 are housed within the housing 102 of FIG. 1.

The housing 102 may comprise any suitable material known in the art, such as plastic or metal. The housing 102 is elongate along a longitudinal axis and has a generally elliptical cross section such that the housing 102 is substantially cylindrical. The housing 102 may have any other shape suitable for housing the heater 104 in other embodiments.

As shown in FIG. 1, the heater 104 comprises two substantially planar ceramic plates. The heater 104 is shown in FIG. 1 flush with the opening 107 for the purposes of illustration. The heating plates of the heater 104 may be inwardly spaced from the opening 107 in other embodiments. The plates are spaced apart within the aerosol generating device 100 to provide a substantially planar cavity 106 adjacent the inner surfaces of each plate. The cavity 106 is sized with respect to the consumable 10 to enable the consumable 10 to slot between the plates of the heater 104 while maintaining contact between the wrapping 14 and the plates of the heater 104. The plates may be held in place within the aerosol generating device 100 by a suitable supportive structure. Each plate comprises a heating element embedded therein for generating heat. In this embodiment, each heating element is an electrically resistive heating wire configured to generate heat in response to an applied electrical current from the battery 112, wherein the controller 108 controls the level of electrical power delivered to each heating wire.

In other embodiments, the heating element could be any other kind of heating element, such as an inductive element. Similarly, the heater 104 could comprise any other suitable material alternatively or in addition to ceramic, such as metal. The arrangement of FIG. 1 having two planar ceramic heating plates has been found to be an efficient means of generating an aerosol and is therefore preferred. However, other suitable shapes and forms of heaters and aerosol generating devices as known in the art may be implemented in other embodiments of the invention in conjunction with other types of consumables.

The button 110 can be replaced with any other suitable input mechanism in other embodiments, such as an airflow sensor or a fingerprint sensor. The battery 112 can be any kind of rechargeable or replaceable battery pack as known in the art.

The temperature sensor 114 can be any suitable form of temperature sensor, such as a thermistor or a thermocouple. In the example embodiment of the aerosol generating device 100, the temperature sensor 114 is provided on an outer surface of one of the heating plates of the heater 104 to measure the temperature of the corresponding heating plate directly. In other embodiments, the temperature sensor 114 can be any other kind of sensor or device that measures a temperature or measures a quantity that enables the temperature of the heater 104 to be determined by the controller 108. Similarly, the temperature sensor 114 could be positioned elsewhere inside the aerosol generating device 100 in a position that enables the temperature of the heater 104 to be determined. The temperature sensor 114 is attached to the surface of the heater 104 by a frame, described in greater detail below.

In the embodiment of FIG. 1 a single temperature sensor 114 is provided. In other embodiments, a temperature sensor 114 or other kind of sensor may be provided on each heating plate of the heater 104, each sensor attached by a respective frame.

Next, an example use of the aerosol generating device 100 will now be described.

To begin generating an aerosol, a user can insert the consumable 10 into the cavity 106 through the opening 107 before pressing the button 110. The controller 108 detects the input from the user and turns on the heater 104 in response to the user pressing the button 110. While the heater 104 is operating, the temperature sensor 114 continuously monitors the temperature of one of the heating plates and relays the measured temperatures to the controller 108. The controller 108 uses the measured temperatures to control the electrical power delivered from the battery 112 to the heater 104. For example, the controller 108 may reduce the power delivered to the heater 104 by reducing a duty cycle of the heater 104 when the temperature measured by the temperature sensor 114 exceeds a threshold. The temperature sensor 114 and the amount of power delivered to the heater 104 may be calibrated so that the heater 104 receives a precise amount of power for a given measured temperature. As the heater 104 heats up the tobacco in the consumable 10, aerosol is generated in the cavity 106. The user can inhale through mouthpiece portion 12 of the consumable 10, which draws air through the air inlet to carry the generated aerosol from the cavity 106 to the user.

One issue that can arise over the lifetime of some aerosol generating devices is that the temperature sensor may become dislodged due to rough treatment of the device or degradation of the attachment means used to hold the sensor in place. The amount of power delivered to the heater may be dependent on the reading from the temperature sensor. A slight movement or complete dislodging of the temperature sensor can therefore have a negative effect on the device's ability to reliably heat an aerosol generating substance at a desired temperature.

The aerosol generating device 100 provides a more secure attachment means to mitigate these issues.

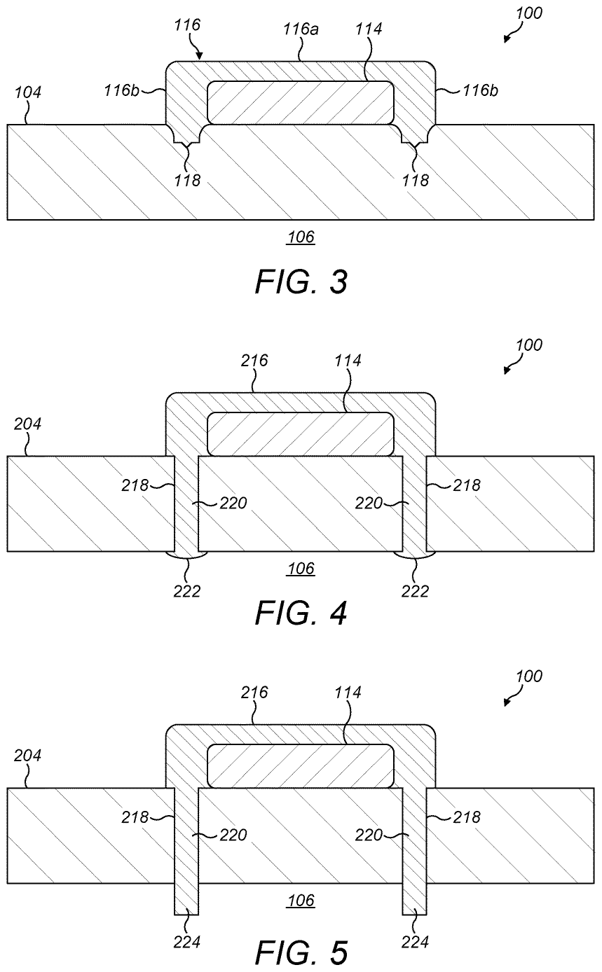

A schematic cross-sectional view of the temperature sensor 114, the heater 104, and a frame 116 of the aerosol generating device 100 is shown in FIG. 3. The frame 116 is configured to hold the temperature sensor 114 securely in position against an outer surface of the heater 104 that is not adjacent the cavity 106. The frame 116 comprises a top panel 116a positioned over the temperature sensor 114 such that the temperature sensor 114 is sandwiched between the top panel 116a and the surface of the heater 104. The frame 116 further comprises two side portions having ends moulded into recesses 118 in the surface of the heater 104. In this embodiment, the top panel 116a and the side portions 116b at least partially enclose the temperature sensor 114 over the heater 104, which prevents movement of the temperature sensor 114 during use. The frame 116 may only partially enclose the temperature sensor 114 and may leave room for a wire of the temperature sensor 114 to connect to the controller 108.

In the embodiment of FIG. 3, the frame 116 is attached to the recesses 118 in the surface of the heater 114 by a process of thermal moulding. The frame 116 is sealed onto the heater 104 once the frame 116 cools at the end of the thermal moulding process. Sealing the frame 116 onto the heater 104 in this way ensures a highly secure fit between the frame 116 and the heater 104 because the frame 116 can melt into and engage with any small crevices or micro-fissures in the surface.

The frame 116 comprises polyether ether ketone (PEEK), which is a heat resistant plastic that can be thermally moulded. In other embodiments, the frame 116 can be made from other thermoplastics or any other suitable material.

The recesses 118 may comprise generally semi-spherical depressions on the surface of the heater 104 with a jagged surface profile that engage with the frame 116 to make a strong seal with the heater 104. In other embodiments, the recesses 118 could be any other suitable bonding feature of the heater 104 surface or any other appropriate surface to engage with the frame 116. Equally, any other suitable process may be used to attach the frame 116 to the heater 104, as described further below.

FIG. 4 shows an alternative embodiment comprising a frame 216 and heater 204 that may be used in place of the frame 116 and heater 104 in the aerosol generating device 100 to hold the temperature sensor 114 in position. The heater 204 is identical to the heater 104 except that it has holes 218 as a bonding feature rather than recesses 118. Similarly, the frame 216 is identical to the frame 116 except that it has legs 220 that are inserted through the holes 218.

The frame 216 comprises two legs 220 inserted through corresponding holes 218 in the heater 204 that provide a bonding feature for the frame 216 to attach to the heater 104. The legs 220 each comprise a stud 222 having a width larger than that of the holes 218 so that the frame 216 is riveted in place and braced against the inner surface of the heating plate. Each stud 222 is sealed into a corresponding hole 220 by a process of heat staking. This allows the legs 220 and the studs 222 of the frame 216 to provide a securing portion that attaches the frame 216 to the heater 204.

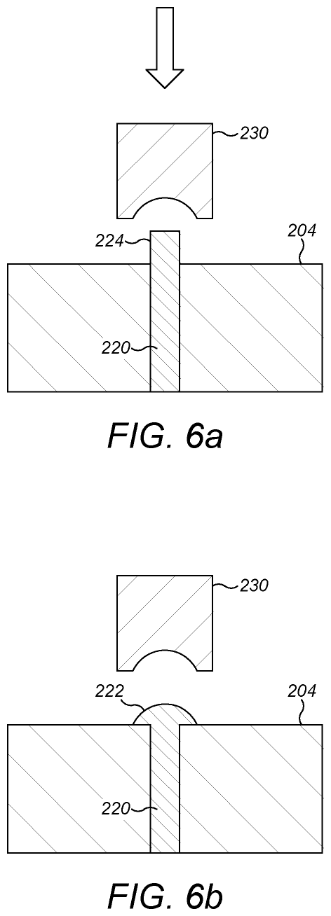

Heat staking is described in more detail below with respect to FIGS. 5, 6A and 6B.

FIG. 5 shows a schematic illustration of a pre-form of the frame 216 prior to the studs 222 of FIG. 4 being formed by heat staking. As shown, each leg 220 comprises an end 224 positioned through and protruding from a respective hole 218. FIG. 6A shows a thermal tip 230 comprising a shaped pressing head having a semi-circular recess. The thermal tip 230 is aligned over a protruding end 224 and is pressed onto the end 224. The thermal tip 230 is heated during use and is sufficiently hot to melt the material of the frame 216 onto the inner surface of the heater 204. The protruding end 224 melts and takes the semi-circular shape of the recess of the thermal tip 230 to form the stud 222 as shown in FIG. 6B. The frame 216 is thus sealed to the heater 204 once cooled.

In some embodiments the aerosol generating device 100 may comprise a supportive structure for the heater 104 or the heater 204 made from the same material as the frame 116 or the frame 216. The frame 116 or the frame 216 may be attached to the heater 104 or the heater 204 at the same time as the supportive structure is bonded to the heater 104 or the heater 204.

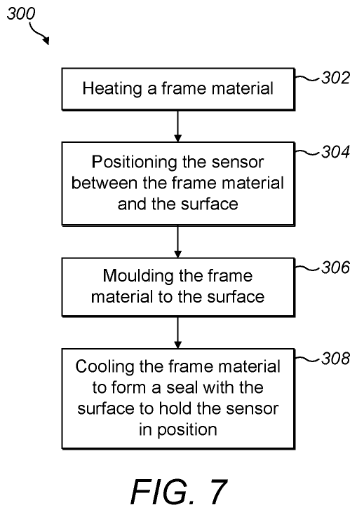

FIG. 7 shows a method 300 of securing a sensor to a surface in a manufacturing process for an aerosol generating device according to an embodiment of the invention. The method 300 may be used to attach the frame 116 to the heater 104 or the frame 216 to the heater 204. The skilled person would appreciate that the method 300 could be used to for any other suitable aerosol generating device to manufacture various embodiments of the invention described above.

The method 300 begins by heating a frame material in step 302. The frame material can be heated using an oven, furnace or the like until at least a portion of it becomes molten or malleable. This allows the molten or malleable part to conform to the surface to attach to the surface. In some examples, a preform of the frame may be used, such as the frame 216 shown in FIG. 5, and only a portion of the preform may be heated to a malleable state, such as the protruding ends 224. In another example, only a lower part of the side portions 116b of the frame 116 may be heated to be later pressed into the recesses 118. In other embodiments, a whole preform frame material may be heated to a malleable or molten state so that the resulting frame can conform to the shape of the sensor to better hold the sensor in place. When PEEK is used as a frame material, the PEEK should be heated to a temperature above the glass transition temperature of PEEK, which is approximately 143 degrees Celsius.

In step 304, the sensor is positioned between the frame material and the surface. The frame may be arranged to at least partially enclose the sensor. This enables the frame to hold the sensor in place once cooled. In one example, the sensor may be placed on the surface and the frame material may be arranged over the sensor.

In step 306, the frame material is moulded onto the surface. The frame material may be moulded onto one or more bonding features of the surface to form a more secure attachment once cooled.

In one example, a preform of the frame 116 may be aligned with the recesses 118 and pressed into the recesses 118 of the heater 104. In a similar example, the frame 116 may be overmoulded onto a surface of the heater 104. Overmoulding typically involves melting and injecting a frame material into a mould to produce a desired form. In the case of the frame 116, a mould may be placed around the recesses 118 and the temperature sensor 114 and the frame material may be injected into the mould and the recesses 118.

In a further example, heat staking may be used in step 306. In one implementation, an end 224 of the frame 216 may be pressed against the heater 204 by the thermal tip 230 to rivet the end 224 against the inner surface of the heater 204, as described previously. In this example, legs of a preform similar to the preform shown in FIG. 5 may first be inserted through corresponding holes in the heater 204.

Any other suitable step for moulding the frame material onto the surface may be implemented in other embodiments.

In step 308, the frame material is cooled to form a seal with the surface, such that the frame holds the sensor. The frame material may be actively cooled by quenching or passively cooled by allowing the frame material to reach an ambient temperature. As a result of being heated to at least a malleable state, the cooled frame material is engaged with the texture of the surface to form a strong bond with the surface. This helps to prevent movement of the sensor with respect to the surface.

1. An aerosol generating device configured to generate an aerosol for inhalation by a user, comprising:
a cavity configured to receive a consumable comprising an aerosol generating substance;
a heater positioned adjacent the cavity, and configured to heat the consumable to generate an aerosol;
a sensor configured to measure a quantity that enables the temperature of the heater to be determined; and
a frame configured to hold the temperature sensor between the frame and a surface of the aerosol generating device;
wherein the frame is thermally moulded to the surface, such that the frame is sealed to the surface, to hold the sensor in position.

2. The aerosol generating device of claim 1, wherein the surface is a surface of the heater.

3. The aerosol generating device of claim 1, wherein the surface is substantially flat.

4. The aerosol generating device of claim 1, wherein the surface comprises one or more bonding features configured to engage with the frame.

5. The aerosol generating device of claim 4, wherein at least one of the one or more bonding features comprise one or more holes provided through the surface.

6. The aerosol generating device of claim 5, wherein the frame comprises a securing portion extending through the one or more holes, thereby securing the frame to the surface.

7. The aerosol generating device of claim 1, wherein the frame comprises PEEK.

8. The aerosol generating device of claim 1, wherein the sensor comprises a temperature sensor.

9. The aerosol generating device of claim 1, wherein the heater comprises ceramic.

10. The aerosol generating device of claim 1, wherein the heater is configured to heat a consumable comprising tobacco.

11. The aerosol generating device of claim 1, wherein the cavity is configured to receive a substantially planar consumable.

12. A method of manufacturing an aerosol generating device, the method comprising:
heating a frame material;
positioning a sensor between the frame material and a surface;
moulding the frame material to the surface; and
cooling the frame material to form a seal with the surface such that the frame holds the sensor in position.

13. The method of manufacturing of claim 12, further comprising moulding the frame material to at least one of one or more bonding features in the surface.

14. The method of manufacturing of claim 12, further comprising, before the step of heating the frame material, extending a securing portion of the frame material through one or more holes in the surface.
